(19) United States
(12) Patent Application Publication
(10) Pub. No.: US 2015/0337869 A1
(43) Pub. Date: Nov. 26, 2015

(54) SELF-ORIENTING PISTON SPRING ACCUMULATOR

(71) Applicant: FORD GLOBAL TECHNOLOGIES, LLC, Dearborn, MI (US)

(72) Inventors: Lev PEKARSKY, West Bloomfield, MI (US); Mark DAVIS, Plymouth, MI (US)

(73) Assignee: FORD GLOBAL TECHNOLOGIES, LLC, Dearborn, MI (US)

(21) Appl. No.: 14/282,002

(22) Filed: May 20, 2014

(51) Int. Cl. F15B 1/02; F16J 1/09; F16J 15/16; F15B 1/04; F15B 13/02

(52) U.S. Cl. CPC F15B 1/024; F15B 1/04; F15B 13/02; F16J 15/16; F16J 1/09; F15B 2201/21

(57) ABSTRACT

An accumulator for a vehicle may include a cylinder defining a bore having an inner surface, and a piston moveable within the bore. The piston may include a seal and a guide section defined by a truncated sphere. The guide section orients the piston within the bore such that the seal maintains contact with the inner surface of the bore.

### TECHNICAL FIELD

The present application relates to accumulators for transmissions within vehicle powertrains.

### BACKGROUND

Accumulators are a part of a transmission within a vehicle powertrain. They store hydraulic potential energy when the engine is shutdown. If the internal pressure of the accumulator is less than the pressure from a hydraulic pump, then the hydraulic fluid flows into and fills the accumulator. The accumulator stores this volume of fluid, under pressure, to store potential hydraulic energy. Upon an engine restart command, accumulators supply pressurized hydraulic fluid to the shift elements necessary for the transmission to transmit power following engine startup. This is useful for vehicles utilizing engine start/stop systems.

Engine start/stop systems shut down a vehicle engine when no torque is needed, for example when the vehicle is stopped at a traffic light. This helps reduce fuel consumption, but increases the number of times the engine needs to be restarted. It is advantageous, therefore, to more quickly supply the energy necessary for the shift elements upon an engine restart command.

### SUMMARY

An accumulator for a vehicle includes a cylinder defining a bore having an inner surface, and a piston moveable within the bore. The piston includes a seal and a guide section defined by a truncated sphere. The guide section is configured to orient the piston within the bore such that the seal maintains contact with the inner surface of the bore.

An accumulator includes a cylinder defining a bore and a cylinder axis, and a piston moveable within the bore. The piston has a piston axis. The piston axis and the cylinder axis define a tilt angle. The accumulator further includes a seal disposed on the piston, and a guide section formed on the piston. The guide section has a curvature such that the seal maintains contact with the cylinder at a maximum tilt angle exceeding 2 degrees.

A powertrain for a vehicle includes, an engine, a pump mechanically driven by the engine to pressurize hydraulic fluid when the engine is running, a plurality of shift elements, a hydraulic control system configured to route pressurized fluid from the pump to the plurality of shift elements, and an accumulator configured to store the pressurized fluid and supply the pressurized fluid to the plurality of shift elements when the engine is not running The accumulator includes a cylinder, a piston disposed within the cylinder defining a chamber, and a spring biasing the piston to reduce the volume of the chamber. The piston includes a guide section having a truncated spherical portion.

### BRIEF DESCRIPTION OF THE DRAWINGS

FIG. 1 is a schematic of a vehicle powertrain;

FIG. 2 is a cross-sectional view of a vehicle accumulator;

FIG. 3 is a partial cross-sectional view magnified on a portion of a vehicle piston; and

FIG. 4 is a partial cross-sectional view magnified on a portion of a vehicle piston having a misaligned spring.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

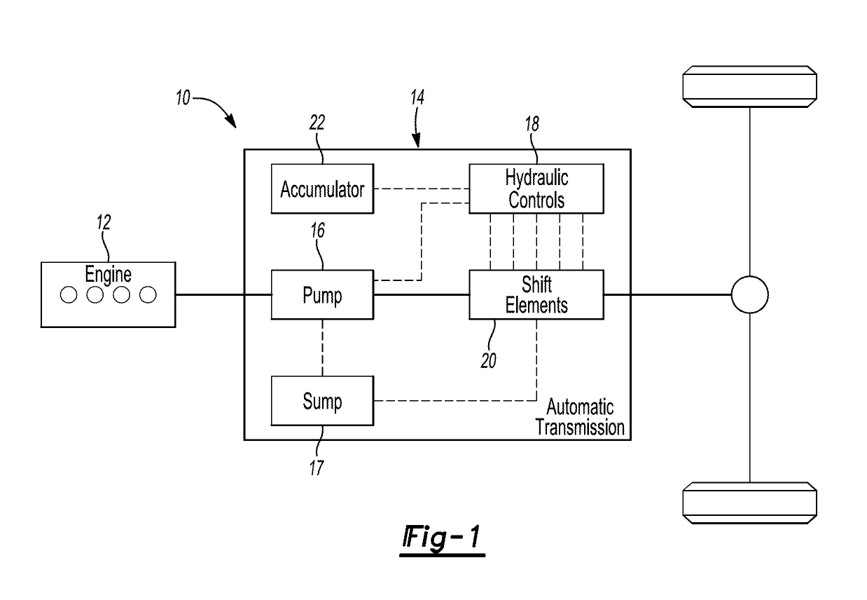

Referring to FIG. 1, a top view of a vehicle powertrain 10 is schematically shown. An engine 12 supplies torque to the transmission 14. The transmission 14 includes a transmission pump 16, hydraulic controls 18, shift elements 20, and an accumulator 22. While the engine 12 is running, the transmission pump 16 is hydraulically interfaced with the hydraulic controls 18. The transmission pump 16 draws fluid from a transmission sump 17. The hydraulic controls 18 direct fluid supplied by the transmission pump 16 to the shift elements 20. The accumulator 22 fills when the pressure from the hydraulic pump 16 is greater than the internal pressure of the accumulator 22.

The larger pressure of the hydraulic pump 16 creates a pressure difference allowing the hydraulic fluid to fill the accumulator 22. When the transmission pump 16 has a pressure less than the pressure within the accumulator 22, the accumulator 22 will not fill. The hydraulic controls, through a valve and check valve, allow the accumulator 22 to store the hydraulic fluid under pressure to maintain a stored hydraulic potential energy while the engine is shutdown to save fuel. The hydraulic controls 18, upon the engine 12 restart command, direct the accumulator 22 to discharge the necessary hydraulic energy to the shift elements 20. Storing more hydraulic energy requires either increasing the packaging space or an accumulator 22 with a higher energy density. An accumulator 22 that stores more hydraulic energy density more quickly energizes the necessary shift elements 20 upon engine 12 restart.

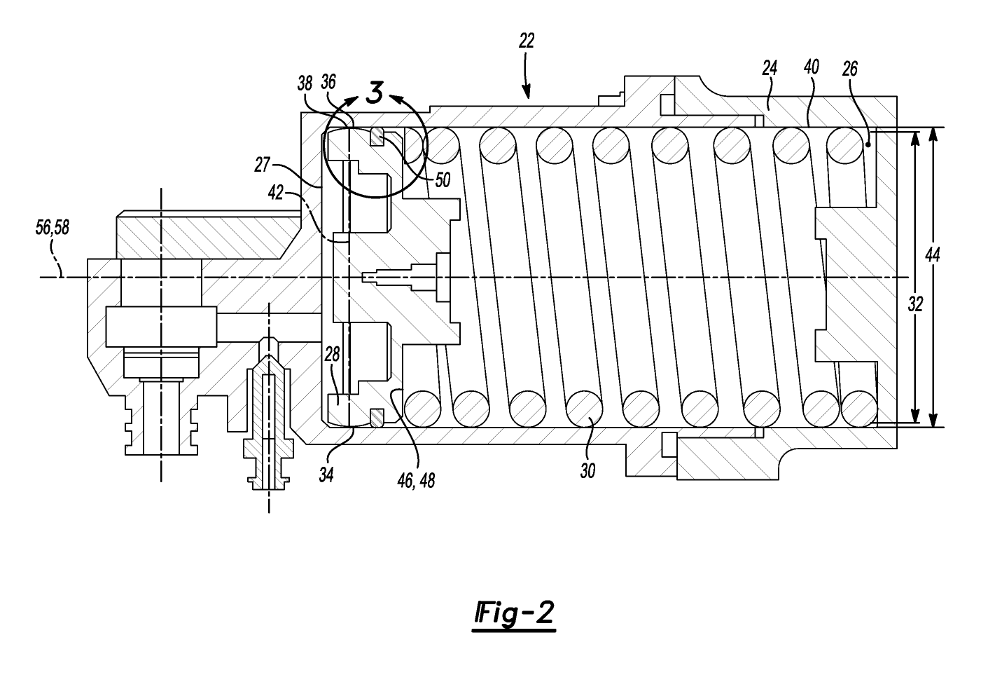

As shown in FIG. 2, an accumulator 22 suitable for vehicle powertrain 10 configurations comprises a cylinder 24 defining a bore 26, a piston 28 movable within the bore 26, and a spring 30 configured to bias the piston 28 within the bore 26. Misalignment of the spring 30 may result in increased wear on the piston 28 and may increase damage to the piston 28 resulting from a friction drag force between the piston 28 and the cylinder 24. Compensating for this added wear and accounting for the frictional drag force typically involves using a piston 28 with a long length to diameter ratio, for example higher than 1.2, and guide bushings on the inside of the cylinder 24. This reduces packaging space within the bore 26 and reduces the energy storage capability for a given available packaging space of the accumulator 22.

FIG. 2 shows a cross-section of an accumulator 22 for a vehicle according to the present disclosure. The accumulator 22 comprises a cylinder 24, a spring 30, and a piston 28. The cylinder 24 defines a bore 26 that has an inner diameter 32. Reducing the length to diameter ratio of the piston 28, through removal of a piston skirt and eliminating the need for the guide bushings, allows for an increase of the spring 30 outer diameter 44. Removing the piston skirt removes the constraints on the spring 30 outer diameter 44, thereby increasing the potential hydraulic energy density of the accumulator 22.

As stated above, packaging space within the accumulator 22 may be important. Increasing the packaging space, thereby allowing for a spring 30 with a larger outer diameter 44 to fit within the piston 28, increases the hydraulic energy. Storing more hydraulic energy may result in a higher stored energy density. Removing the need for guide bushings increases packaging space within the bore 26 and increases the hydraulic energy density of the accumulator 22.

In order to increase the outer diameter 44 of the spring 30, the piston 28 is formed with a guide section 34. Through heat treating or coating, and low micro finish, for example polishing, the guide section 34 may be formed having a truncated spherical curvature 36. The guide section may be formed using surface hardened steel with a Rockwell hardness of at least 50 RC. This allows the guide section 34 to prevent the wear typically absorbed by the guide bushings. In addition, the truncated spherical curvature 36 of the guide section 34 reduces contact between the piston 28 and the bore 26. The truncated spherical curvature 36 of the guide section 34 reduces the piston surface area 38 moving against the bore 26. This reduces drag imposed by friction and improves accumulator 22 discharge response time.

The lack of piston surface area 38 contact with the cylinder 24, resulting in the reduction in drag of the piston 28 on the cylinder 24, coupled with the increase of hydraulic energy density further allows the accumulator 22 to more quickly supply energy to the shift elements 20 required for engine restart. The accumulator 22 response time may be reduced to approximately 250 milliseconds. This allows a vehicle powertrain 10 to restart the engine 12 before the hydraulic pump 16 is capable of supplying energy to the vehicle transmissions 14. Supplying the hydraulic energy necessary for an engine 12 restart as well as the improved response time of the accumulator 22 improves the overall fuel economy of the vehicle.

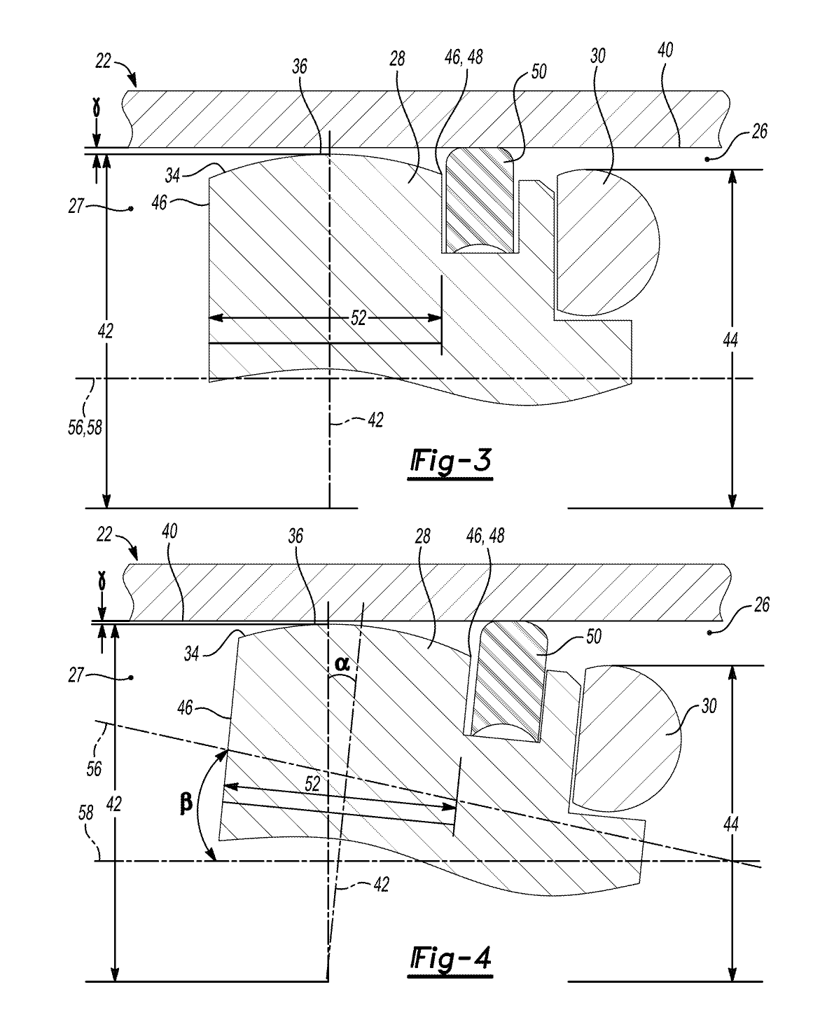

Referring to FIG. 3, a partial magnified cross-section view, A, of the accumulator 22 focused on a portion of the guide section 34 is shown. FIG. 3 depicts the guide section 34 of the piston 28 sitting level on the spring 30.

The diameter 42 of the guide section 34 may be substantially equal to the outer diameter 44 of the spring 30. This provides greater balance of the piston 28 on the spring 30 to further reduce drag between the piston 28 and the inner surface 40 of the bore 26. Further, the diameter 42 of the guide section 34 may also substantially equal the inner diameter 32 of the bore 26. Therefore, the outer diameter 44 of the spring 30 may be substantially equal to the inner diameter 32 of the bore 26. The increased bore packaging space allows the spring 30 to have a larger outer diameter 44. With a larger outer diameter 44, the spring 30 is able to further support the piston 28 under a higher pressure. This allows for an increase in pressure in the cylinder 24 and as such an increase in the hydraulic energy density of the accumulator 22.

A spring 30 with a larger outer diameter 44 is able to support a greater volume of hydraulic fluid which may increase the pressure within the cylinder 24. The increase in volume and the resulting increase of pressure results in an increase in the hydraulic energy density of the accumulator 22. Increasing the hydraulic energy density of the accumulator 22 improves the response time of the accumulator 22. Storing a greater volume of hydraulic fluid under a greater pressure, through the use of a valve and check valve, permits the accumulator 22 to more quickly energize the shift elements.

Further, the increase in the spring diameter 44 allows the accumulator 22 to have a longer piston stroke volume. A spring 30 with a larger outer diameter 44 is able to compress further, allowing the piston 28 to have a longer stroke. Increasing the stroke volume of the piston 28 allows the accumulator 22 to have a higher hydraulic energy density. As stated above, a high hydraulic energy density allows the accumulator 22 to respond faster when supplying hydraulic energy to the transmission 14. Therefore, increasing the diameter 44 of the spring 30 and forming the guide section 34 with a diameter 42 substantially equal to the outer diameter 44 of the spring 30 allows for a significant reduction in response time of the accumulator 22.

Referring to FIG. 4, a partial magnified cross-section view, A, of the accumulator 22 on a portion of the guide section 34 of the piston 28 is shown. The guide section 34 may be formed with a curved surface 36 and two straight edges 46. The two straight edges 46 truncate the spherical nature of the curved surface 36. This allows the piston 28 to be self-orienting. The piston 28 floats on the sprint 30 within the bore 26 of the cylinder 24 and the spring 30 biases the piston 28 toward an end 27 of the bore 26. A small misalignment α in the spring 30 tilts the piston 28 causing contact between the guide section 34 and an inner surface 40 of the bore 26.

For example, the spring 30 may be misaligned by approximately 2°. This small degree misalignment α may result in a tilt of the piston 28 against the inner surface 40 of the bore 26. When the piston 28 is tilted on the spring 30, the curved surface 36 of the guide section 34 may contact the inner surface 40 of the bore 26. The guide section 34 acts as an adjustment mechanism compensating for the misalignment α of the spring 30.

Being tilted reduces a clearance γ between the guide section 34 and the bore 26. By reducing the clearance γ between the guide section 34 and the bore 26, the distance between a base edge 48 of the piston 28 and an inner surface 40 of the bore 26 is increased. This is due to the angular misalignment α of the spring 30. The increase in clearance γ may require the piston 28 to maintain a seal 50, at a greater distance, with the inner surface 40 of the bore 26. The guide section 34, having a diameter 42 substantially equal to the inner diameter 32 of the bore 26, accounts for this increase in clearance γ and allows the piston 28 to maintain a seal 50 with the inner surface 40 of the bore 26.

The guide section 34 accomplishes this through a ratio between the length 52 and diameter 42 of the curved surface 36. The ratio of the length 52 to diameter 42 of the guide section 34 is greater than a tangent of the misalignment α of the spring 30. This allows the guide section 34 to compensate for the misalignment α of the spring 30. The ratio of the length 52 and diameter 42 may be such that the guide section 34 compensates for greater than 5° of a tilt angle β between a piston axis 56 and a cylinder axis 58.

Since the guide section 34 compensates for a tilt angle β greater than 5° and the misalignment α of the spring 30 may be approximately 2 to 3°, the guide section 34 is further configured to account for and orient the piston 28 within the bore 26. The truncated spherical curvature 36 of the guide section 34 orients the piston 28 within the bore 26. A self-orienting guide section 34 allows the piston 28 to float on the spring 30 without the use of guide bushings. The guide section 34, therefore as part of the piston 28, allows the piston 28 to self-orient within the bore 26 despite floating on a misaligned spring 30. This allows the cylinder 24 to utilize a spring 30 having larger outer diameter 44, despite the potential small degree misalignment α of the spring 30. The self-orienting guide section 34 may increase the hydraulic energy density of the accumulator 22 by approximately 20%.

The truncated spherical curvature 36 of the guide section 34 further prevents binding between the piston 28 and the bore 26. As explained above, the curved surface 36 of the guide section 34 minimizes contact between the piston 28 and the inner surface 40 of the bore 26. Due to the spherical nature of the curved surface 36, the piston 28 may only contact the inner surface 40 of the bore 26 at a single point. Therefore, even despite a misalignment a of the spring 30, the guide section 34 of the piston 28 further aids in reducing wear on the piston 28. Minimizing the contact between the piston 28 and the inner surface 40 of the bore 26 allows the accumulator 22 to last longer. This may save time, cost, and manufacturing expenses.

Reducing the binding between the inner surface 40 of the bore 26 and the guide section 34 further reduces the friction drag force between the piston 28 and the cylinder 24. Reducing the drag force not only reduces damage to the guide section 34 of the piston 28 due to friction, but also improves the response time of the accumulator 22. Further, reducing the friction drag force allows the accumulator 22 to use the hydraulic energy to energize the shift elements 20, rather than using the hydraulic energy to overcome the friction drag force. Therefore the guide section 34 allows the accumulator 22 to store more potential hydraulic energy, have a higher energy density, and an improved response time.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

1. An accumulator for a vehicle comprising:
a cylinder defining a bore having an inner surface; and
a piston moveable within the bore, the piston including a seal and a guide section defined by a truncated sphere, the guide section configured to orient the piston within the bore such that the seal maintains contact with the inner surface of the bore.

2. The accumulator of claim 1 further comprising a spring disposed within the bore and configured to bias the piston toward an end of the bore.

3. The accumulator of claim 1 wherein the guide section is formed using surface hardened steel having a Rockwell hardness of at least 50 RC.

4. The accumulator of claim 2 wherein the guide section has a diameter and a length, the spring has a misalignment angle, and a ratio of the guide section length to the guide section diameter is greater than a tangent of the misalignment angle.

5. The accumulator of claim 4 wherein the misalignment angle is less than 2 degrees.

6. The accumulator of claim 4 wherein the ratio of the length to the truncated sphere diameter is greater than a tangent of 5 degrees.

7. An accumulator comprising:
a cylinder defining a bore and a cylinder axis;
a piston moveable within the bore, the piston having a piston axis, the piston axis and the cylinder axis defining a tilt angle;
a seal disposed on the piston; and
a guide section formed on the piston, the guide section having a curvature such that the seal maintains contact with the cylinder at a maximum tilt angle exceeding 2 degrees.

8. The accumulator of claim 7 wherein the guide section defines a truncated sphere.

9. The accumulator of claim 7 further comprising a spring configured to bias the piston towards an end of the cylinder, the spring having a spring axis, the spring axis and the cylinder axis defining a misalignment angle less than the maximum tilt angle.

10. The accumulator of claim 7 wherein the length to diameter ratio of the guide section is such that the seal maintains contact with the cylinder at the maximum tilt angle.

11. A powertrain for a vehicle comprising:
an engine;
a pump mechanically driven by the engine to pressurize hydraulic fluid when the engine is running;
a plurality of shift elements;
a hydraulic control system configured to route pressurized fluid from the pump to the plurality of shift elements; and
an accumulator configured to store the pressurized fluid and supply the pressurized fluid to the plurality of shift elements when the engine is not running, the accumulator including a cylinder, a piston disposed within the cylinder defining a chamber, and a spring biasing the piston to reduce the volume of the chamber, wherein the piston includes a guide section having a truncated spherical portion.

12. The powertrain of claim 11 wherein a length of the truncated spherical portion is such that the truncated spherical portion compensates for a misalignment of the spring within the accumulator.

13. The powertrain of claim 11 wherein the truncated spherical portion orients the piston within the cylinder.

14. The powertrain of claim 11 wherein the truncated spherical portion contacts the cylinder at a single point.
